(19) United States
(12) Patent Application Publication
(10) Pub. No.: US 2011/0061293 A1
(43) Pub. Date: Mar. 17, 2011

(54) Tree of life precursor

(76) Inventor: Mac Truong, Jersey City, NJ (US)

(21) Appl. No.: 12/456,128

(22) Filed: Jun. 12, 2009

(51) Int. Cl. A01G 1/00; A01C 7/00

(52) U.S. Cl. 47/58.1 SC; 111/100

(57) ABSTRACT

Dr. Mac Truong's invention described in U.S. Pat. No. 5,799,488 dated Sep. 1, 1998 creates what he calls “Trees of Life”, or “Forest of Life”, i.e. trees grown from ashes of identified individual human beings, representing deceased people's embodiment after their death. In this invention the same inventor invents what he calls “Tree of Life Precursor” or “Advanced Tree of Life” or “Trees of Life of living people.”

As such everybody who desires it may have a Tree of Life Precursor created and growing while he/she is still alive, and once he/she is dead, his/her family would not have to undergo any pain, inconvenience, complication or embarrassment of burial or other methods of funerals. They only have to deposit the ashes of their deceased loved one at the roots his/her “Tree of Life Precursor” or “Advanced Tree of Life”, which becomes the conventional “Tree of Life” being created pursuant to the method described in Dr. Mac Truong's U.S. Pat. No. 5,799,488.

### BACKGROUND

1. Field of Invention

This invention relates to methods for educating humans to appreciate that there is ongoing life notwithstanding the death of a particular human. This invention relates to methods of alleviating the grief and pain occurring upon the death of a loved one. This invention relates to methods for educating humans to cherish the total environment for preservation of Mother Earth for future generations. This invention relates to the growing and nursing of precursors of trees from seeds or seedlings by controlling the composition of the nutrient composition in which a seed or seedling will undergo significant growth for becoming a treelet. This invention relates to methods for rendering trees and plants much more valuable and attractive to human beings from both emotional and commercial points of view. This invention relates to methods for recycling and disposing of human parts and/or dead bodies in a more effective, respectful and productive manner. This invention relates to methods for creating a permanent material link between a particular human being and a particular tree or plant.

2. Prior Art

(1) Traditional Prior Art

For more than one million years, humans have been fascinated with the planting of seeds for trees and the nurturing of seedlings for more satisfactory growth during the transformation into viable trees. The mortality rate of seedlings and the poor germination rates of nuts and other seeds capable of maturing into trees has been a challenging problem for many generations. Even before the invention of any language, humans had developed significant skills concerning tree farming, tree nurseries, and special skills concerning the nurturing of seeds and seedlings through their early stage of growth.

For more than one million years, humans have been fascinated by the beauty of trees and plants. Humans have always tried to make trees and plants as beautiful and as valuable as possible for both sentimental and commercial purposes. Methods for making trees and plants more beautiful, more attractive or in brief more commercially valuable have been invented and practiced. New and better methods to achieve that purpose are yet to be found.

For possibly more than ten million years, humans have had traumatic problems in coping with the grief attributable to the death of a loved one. Actually no existing method known has sufficiently appeased the said pain and grief. New and better methods to achieve that purpose are yet to be found.

For possibly more than ten million years, humans have had traumatic problems in coping with the problems attributable to the disposal of the corpses of the loved ones, who died. In our time the said problem is growing in large and crowded cities, where spaces for cemeteries could be better used for parks or botanic gardens. Some methods of disposing of dead bodies have been invented but every existing method has its shortcomings. None of the existing methods would satisfy both the family of the decedent and the community as a whole. None of the existing methods would contribute to the preservation of the earth and life in general. New and better methods to satisfactorily dispose of and recycle dead human bodies are needed and must be invented.

In some areas in which carrion birds such as vultures have been abundant, it has been the customs for the corpse of a dead human being to be made available for vultures and the like. In other areas, a human corpse has been buried under conditions favoring biological deterioration such that none of the remains of the corpse are conspicuous within a few centuries. The remains of most human ancestors cannot be identified. New and better methods for satisfactorily dispose of and recycling dead human bodies and identified them for future generations to preserve such loving memories of the deceased ones are needed and must be invented.

Wealthy families being concerned with making an ostentatious display of their wealth have erected tombstones in cemeteries where corpses of their loved ones were buried, sometimes in concrete vaults protecting the corpses from contact with soil microorganisms for centuries. Tombstones, church windows and other memorials provide evidence of an ongoing search by survivors for visible reminders that a deceased person was appreciated and loved when living. The ongoing experimentation has demonstrated that the long standing demand for such services has not been satisfactorily met. New and better methods for satisfactorily disposing of and recycling dead human bodies and identifying them for future generations to preserve such loving memories of the deceased loved ones are needed and must be invented.

Facts show that human civilization and the growth of trees and plants go in opposite directions. The more human societies develop, the more trees and plants are destroyed. In recent years humans are more aware of the crucial importance of trees and plants for life on earth. If humans do not timely stop the destruction of forests, they will all perish one day. The earth would be like Mars. New and better methods to satisfactorily enhance the effective and fervent preservation of forests and plants that is necessary for the survival of the human race on this planet are needed and must be invented.

New and better methods are needed and must be invented to create a sense of respect and strong feeling by human beings for trees and plants and to encourage humans to lovingly preserve trees and plants for the benefit of humankind and all other living organisms on this planet.

(2) Modern Prior Art Taught by

Dr. Mac Truong's U.S. Pat. No. 5,799,488

As a solution to the issues and needs of most members of humankind generally identified in the above section about Prior Art, inventor Mac Truong, Ph.D., J. S. D., secured U.S. Pat. No. 5,799,488 on Sep. 1, 1998.

According to Dr. Mac Truong's said invention, a grove characterized by more than one trees, each one of which was grown from a seed or seedling in a nutrient composition featuring the dirt-like material, preferably ashes, derived from the remains of a deceased human. Each of those trees is individually identified as the embodiment of the ongoing life of each particular deceased human being. Commercially Dr. Truong names those trees “Trees of Life” and the grove of these trees “Forest of Life.” For convenient purpose we shall also refer to Dr. Mac Truong's such invention by such names.

The invention of Tree of Life and Forest of Life by Dr. Mac Truong has received tremendous support and warmest reception by most human beings who happen to love trees and learn of the invention.

However the Tree of Life can only be realized after a particular individual has died, not before. Hence new and better methods are needed and must be invented to create a sense of respect and strong feeling by human beings for trees and plants and to encourage living humans to passionately preserve trees and plants for the benefit of humankind and all other living organisms on this planet while the tree-loving people are still alive, capable, willing and earnest to do so.

Secondly the Tree-of-Life invention cannot solve the critical issue raised in the deceased person's family, who may strongly disagree with one another about whether or not the dead person should become a Tree of Life. Hence new and better methods are needed and must be invented to alleviate the family of the deceased person of any agonizing pain of arguing with one another about whether the corpse of their deceased loved one should become a Tree of Life.

Thirdly the Tree-of-Life invention cannot solve the critical issue raised in the dead person's family, who may strongly disagree with one another about which kind of tree the dead person should become. Hence new and better methods are needed and must be invented to alleviate the deceased person's family of agonizing pain of arguing with one another about which kind of tree the corpse of their deceased loved one should become.

Fourthly the Tree-of-Life invention cannot solve the problem raised in the dead person's family, who may strongly disagree about where and when his/her Tree of Life should be planted and preserved. Hence new and better methods are needed and must be invented to help the family of the deceased person not even to have to go through the traumatizing pain of arguing with one another about this issue, which may be very unpleasant and cause serious discord among the livings, leading often to no Tree of Life grown or maintained at all.

Fifthly the Tree-of-Life invention cannot solve the problem raised in the dead person's family, who may strongly disagree about who should pay for the costs of creating and/or maintaining the Tree of Life of the dead person. Hence new and better methods are needed and must be invented to help the family of the deceased person to cope with this issue, which may become very unpleasant and cause serious disputes among the livings, instead of facing no problem at all at a time they do not need dividing arguments but rather great vision, loving inspiration, peace and unity.

### SUMMARY OF THE INVENTION

A living tree created from a seed or seedling that germinates in and grows from a mixture of blood and/or other bodily tissues carrying DNA taken from the body of a living identified human individual and soil and water and other necessary nutrients for a treelet to grow in an area scheduled for visiting by the said living identified human, who may be called the “owner” thereof, and other persons desiring to be near and take care of that tree, which becomes the new embodiment of the “owner” in this life, second only in sentimental value to his physical body.

Once the “owner” is dead his or her body will be cremated or reduced to dirt-like material by his/her loved ones and his/her ashes or dirt-like material will be carefully fed to the roots of the tree, which then becomes a permanent Tree of Life pursuant to Dr. Mac Truong's invention described in U.S. Pat. No. 5,799,488 dated Sep. 1, 1998.

### DRAWING

In the accompanying drawing,

FIG. 1 is a flowchart, and

FIG. 2 is a perspective view of a grove of trees, each having a plaque identifying the living human individual, whose blood and/or dirt-like material of his/her former organ(s) or body part(s) fertilized such unique tree. Additional blood and/or dirt-like material of his/her former organ(s) or body part(s) can be fed to the root of the tree through a feeder, which is essentially composed of a container and a tube that conducts the liquid or dirt-like material deposited in the container to the root of the tree in a controlled manner.

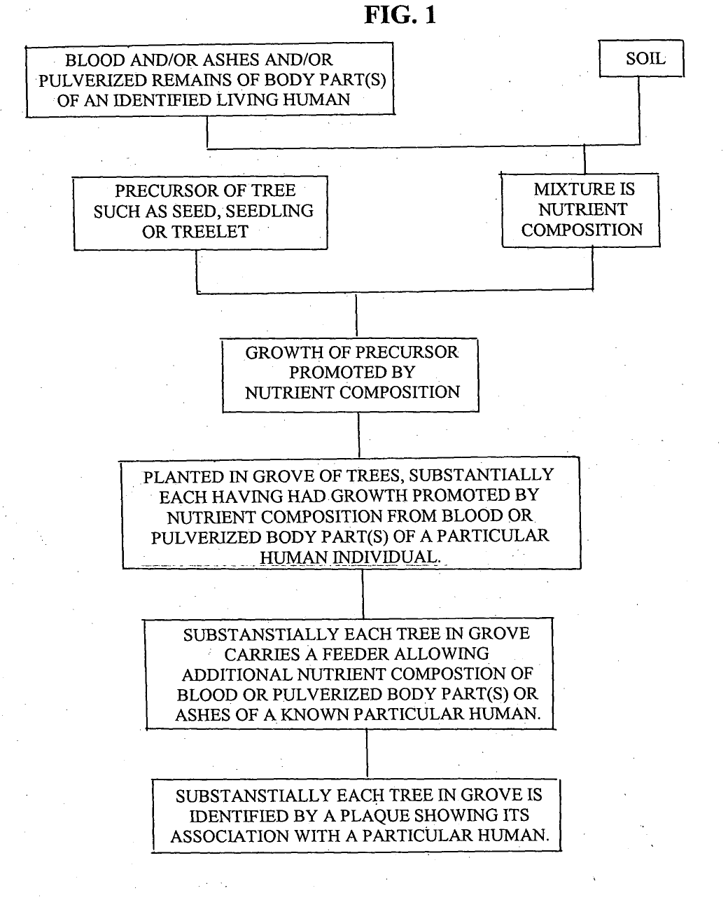

In FIG. 1 the flowchart shows the several steps of preparing a park of trees.

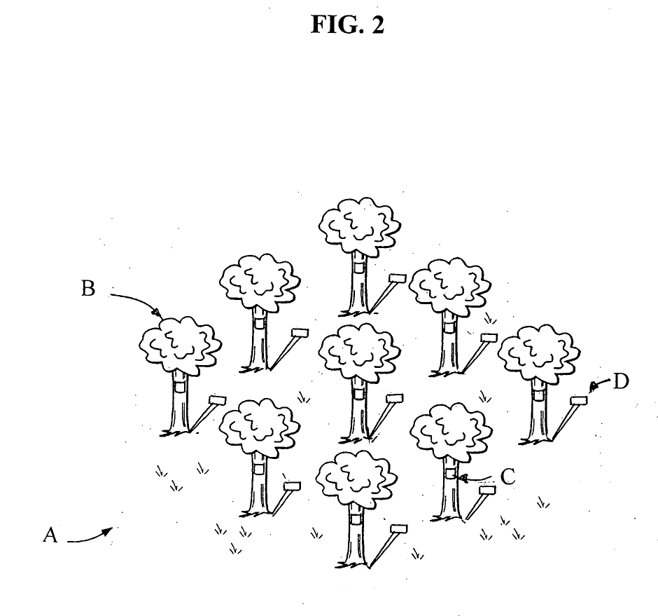

In FIG. 2 a park of trees features a group of trees [A], specially each tree [B] carrying a plaque [C] identifying the particular living human whose blood and/or dirt-like material of his/her former organ(s) or body part(s) fertilized such unique tree, and a feeder [D] conducting the liquid or dirt-like material deposited in the container to the root of the tree in a controlled manner.

### DESCRIPTION OF PREFERRED EMBODIMENTS

### Example 1

While a man is living, with a view of creating a significant physical link between him and a new living being, that has not existed before, such as an apple tree, which would serve him as his new embodiment, second from a psychological point of view only to his present physical body, he voluntarily gives an ounce or more of his blood, that would be mixed with damp soil and other nutrients necessary for an apple seed to germinate and grow. The whole nutrient composition prepared that way shall be placed in a nursery pot.

In order for the seed to germinate, for the seedling to grow into a treelet, for the treelet to grow into a young tree, and for a young tree to grow into a mature tree, a variety of nurturing conditions must be provided. For example, water should be provided throughout appropriate stages of the growth. Trees require sunlight, carbon dioxide in the atmosphere and other desirata. Different nutrient compositions may be advantageous for different trees. All of the specialized knowledge concerning appropriate techniques, compositions, methods, etc. past, present and future concerning the growing of trees can be utilized when practicing the instant invention, which is concerned with the improvement of the incorporation by the seedling or treelet of the blood and DNA or some other dirt-like material, preferably ashes, derived from the body of a living human being, who wishes to have a physical link with such tree so created.

In this example, a selected seed from an apple tree is planted in such nutrient composition and nurtured carefully to enhance the likelihood of germination of the seed and growth of the seedling into an apple tree. If there is failure to germinate and/or grow satisfactorily, the same nutrient composition, enriched by the products from the previous attempt(s) would be used for other seed(s) until a viable tree was assured. Such procedure, constantly aiming at creating a unique link between the blood of a living human and a particular grown tree, differs significantly from traditional production of the maximized number of viable trees with minimized costs. Such tree comprising components derived uniquely from the blood of a particular deceased human carries a plaque indicating the identity of the person, whose blood it now carries within itself.

### Example 2

The ashes of, or dirt-like material deriving from the cut-off organ(s) or parts, such as a kidney, part of a stomach, half of a liver or a leg or hand of a living multimillionaire woman, who has recently sustained a serious dismembering but not fatal accident or a surgical operation, are mixed with soil and water so that the resulting nutrient composition contains approximately 10% ashes or dirt-like material and 90% soil. A walnut is planted in such mixture, leading to the growth of a walnut tree. The residue of said nutrient composition continues to nurture the tree because such residue accompanies the roots during whatever transplanting occurs. A significant portion of the ashes or dirt-like material with DNA intact are transformed into and becomes constitutive elements of the walnut tree.

Such procedure, constantly aiming at creating a unique link between the dirt-like bodily material of a living human and a particular grown tree, differs significantly from traditional production of the maximized number of viable trees with minimized costs. Such tree comprising components derived uniquely from the dirt-like bodily material of a living human carries a plaque indicating the identity of the person whose dirt-like bodily material it now carries within itself.

### Example 3

After a tree was created and grew in the manner described in Examples 1 and 2 above, the person, whose blood and/or dirt-like bodily material has been absorbed by the tree through its root system, may from time to time create more trees in the same manner, or continue to feed the roots of the Tree of Life Precursor that has already germinated and grown with new blood supply or dirt-like bodily material.

At the death of such person, his/her loved ones cause his/her corpse or part thereof cremated or reduced to dirt-like bodily material and deposit such ashes or dirt-like material at the root of the Tree of Life Precursor as the permanent embodiment of the deceased person.

Heretofore various pesticides, plant hormones, and similarly biological pertinent components may continue to be employed in the soil in which the seed or seedling has been nurtured into a treelet. Similarly glass beads, pebbles and the like are employed to stimulate appropriate branching and bending of the growing roots. All such modifiers of past present and future technology can be included in the nutrient composition of the instant invention.

Heretofore the owner of the Tree of Life Precursor or object of the instant invention may purchase a large chunk of the Rain Forest and implant her Tree of Life Precursor together with those of her close relatives and friends, and transform such land into a magnificent botanic garden while meticulously and fully respecting the local ecological system in such a way that the botanic garden so created, and being called “Forest of Life” by Dr. Mac Truong, inventor holding U.S. Pat. No. 5,799,488, does not degrade but on the contrary contributes effectively to the preservation of the Rain Forest for all humankind to enjoy in the years to come.

Many variation and modification of the invention are possible, and the illustrative examples are merely illustrative of the invention. It is only in the claims, susceptible to amendment during prosecution, that there has been an attempt to limit the scope of the invention.

The invention claimed is:

1. The method of preparing a grove of trees composed of more than one trees, each one of which having been grown in a nutrient composition comprising the blood and/or ashes and/or dirt-like bodily material of a particular living human, a significant portion of such trees having been derived by natural absorption of such blood and/or ashes and/or dirt-like bodily material of a particular living human, each such tree having been prepared by a method which comprises the steps of:
(a) collecting blood or producing individualized ashes or dirt-like bodily material from an organ or dismembered part of the body of a known living human individual;
(b) preparing a nutrient composition characterized by the incorporation therein of said blood and/or ashes or dirt-like bodily material from an organ or dismembered part of the body of a known living human individual, which blood and/or ashes and/or dirt-like bodily material constitutes from 1% to 99% of the nutrient composition;
(c) planting a precursor of a tree in said nutrient composition;
(d) nurturing said precursor rooted in said nutrient composition for growth transformation into a treelet, whereby whatever growth is attributable to the blood and/or ashes or dirt-like bodily material from an organ or dismembered part of the body of a known living human individual is significantly attributable only to said particular living human individual; and
(e) providing a plaque identifying such tree as a new living physical embodiment of the said particular living human individual in addition to his/her current physical body;

2. The method of claim 1 in which the precursor is a seed.

3. The method of claim 1 in which the precursor is a seedling.
